(19) United States
(12) Patent Application Publication
(10) Pub. No.: US 2013/0241803 A1
(43) Pub. Date: Sep. 19, 2013

(54) SCREEN SHARING APPARATUS, SCREEN SHARING METHOD AND SCREEN SHARING PROGRAM

(71) Applicant: Hiroyuki KOBAYASHI, Tokyo (JP)

(72) Inventor: Hiroyuki KOBAYASHI, Tokyo (JP)

(73) Assignee: NEC Corporation

(21) Appl. No.: 13/795,178

(22) Filed: Mar. 12, 2013

(30) Foreign Application Priority Data
Mar. 14, 2012 (JP) 2012-056975

(51) Int. Cl. G06F 3/14

(52) U.S. Cl. CPC G06F 3/1454
USPC 345/2.2

(57) ABSTRACT

A screen reception apparatus according to an exemplary aspect of the invention includes, a block image information storage unit that stores therein a plurality of block images resulting from segmentation of an entire image which is scrolled by software so that a display area, which is part of the entire image, is displayed on a first screen, as well as identifications of the respective block images, such that the block images and the identifications are correlated with each other; and an on-screen display unit that receives one of the identifications and display location within the first screen reads out from the block image information storage unit one of the block images corresponding to the received identification and, display the read out block image at the display location within the first screen.

This application is based upon and claims the benefit of priority from Japanese Patent Application No. 2012-056975, filed on Mar. 14, 2012, the disclosure of which is incorporated herein in its entirety by reference.

### TECHNICAL FIELD

The present invention relates to a screen sharing apparatus, a screen sharing method and a screen sharing program which enable realization of speeding up the function of sharing application execution screens among a plurality of information terminals.

### BACKGROUND ART

With the development of an IT environment in recent years, there has been increasing a case where a conference is held in the form of a TV conference, a Web conference or the like. When presentations are made in such a TV conference or a Web conference, it is essential to share application execution screens among attendants' information terminals. At this time, any large amount of time in data transfer for execution screens causes a time difference between a screen operated by a presenter and a screen viewed by each of attendants, thereby sometimes making it difficult for the attendants to understand the content of the presentation. Accordingly, in the TV conference or the Web conference, it is one of important problems how to realize speeding up of the function of sharing application execution screens.

As an example of technologies related to this problem, there is disclosed an image data transmission method in Japanese Patent Application Unexamined Publication No. 2005-269272. In this image data transmission method, image data included in each frame is divided into a plurality of block areas, and only image data included in block areas thereof each having at least one change in image data from an immediately previous frame is transmitted.

As another example of technologies related to the problem, there is disclosed an image data transmission method in Japanese Patent Application Unexamined Publication No. 2009-245254. In this image data transmission method, a transmission side apparatus determines a block size of block images to be transmitted to a reception side apparatus on the basis of processing power of the transmission side apparatus itself and/or the reception side apparatus, and then transmits the block images.

### SUMMARY

In the aforementioned technology disclosed in Japanese Patent Application Unexamined Publication No. 2005-269272, in the case where, during sharing of an application execution screen, image data of a certain frame wholly changes to a large extent as compared with image data of an immediately previous frame because of scrolling by one screen at a time, or the like, it is necessary to transmit the whole block images of the certain frame, so that the slowing down of screen sharing processing is inevitable.

Further, in the aforementioned technology disclosed in Japanese Patent Application Unexamined Publication No. 2009-245254, in the case where the transmission side apparatus and/or the reception side apparatus are/is in a heavy load state due to influence of other executing programs, even if a load on processing for transmitting image data is reduced by changing the block size of transmitted images, there is still a limit in optimization, so that the slowing down of screen sharing processing may be inevitable.

It is an important problem to speed up the function of sharing application execution screens irrespective of the state of a shared application execution screen, loads on relevant apparatuses or the like.

An object of the present invention is to provide a screen sharing apparatus, a screen sharing method and a screen sharing program which make it possible to solve such a problem as described above.

A screen reception apparatus according to an exemplary aspect of the invention includes, a block image information storage unit that stores therein a plurality of block images resulting from segmentation of an entire image which is scrolled by software so that a display area, which is part of the entire image, is displayed on a first screen, as well as identifications of the respective block images, such that the block images and the identifications are correlated with each other; and an on-screen display unit that receives one of the identifications and display location within the first screen reads out from the block image information storage unit one of the block images corresponding to the received identification and, display the read out block image at the display location within the first screen.

A screen reception method according to an exemplary aspect of the invention includes, storing therein a plurality of block images resulting from segmentation of an entire image which is scrolled by software so that a display area, which is part of the entire image, is displayed on a first screen, as well as identifications of the respective block images, such that the block images and the identifications are correlated with each other to a first memory area; and receiving one of the identifications and display location within the first screen reads out from the first memory area one of the block images corresponding to the received identification and, display the read out block image at the display location within the first screen.

A non-transient computer-readable recording medium recording thereon a program which makes a computer having a block image information storage unit that stores therein a plurality of block images resulting from segmentation of an entire image which is scrolled by software so that a display area, which is part of the entire image, is displayed on a first screen, as well as identifications of the respective block images, such that the block images and the identifications are correlated with each other; and an on-screen display unit that receives one of the identifications and display location within the first screen reads out from the block image information storage unit one of the block images corresponding to the received identification and, display the read out block image at the display location within the first screen.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of a screen sharing apparatus according to a first exemplary embodiment of the present invention.

FIG. 2 is flowchart illustrating operation of application sharing start processing according to a first exemplary embodiment of the present invention.

FIGS. 3A to 3B are flowcharts illustrating operation during sharing of an application, according to a first exemplary embodiment of the present invention.

FIG. 4 is diagram illustrating an example of storage of block image data included in a first display image in application sharing start processing according to a first exemplary embodiment of the present invention.

FIG. 5 is a diagram illustrating an example of storage of block image data included in a second display image in application sharing start processing according to a first exemplary embodiment of the present invention.

FIG. 6 is a diagram illustrating an example of transmission of ID information and location information related to block images during sharing of an application (in the case where there is no update in block image data), according to a first exemplary embodiment of the present invention.

FIG. 7 is a diagram illustrating an example of transmission of ID information and location information related to block images during sharing of an application (in the case where there are some updates in block image data), according to a first exemplary embodiment of the present invention.

FIG. 8 is a block diagram illustrating a configuration of a screen sharing apparatus according to a second exemplary embodiment of the present invention.

FIG. 9 is a diagram illustrating an example of calculation of location information related to block images performed by an image information transmission unit according to a second exemplary embodiment of the present invention.

FIG. 10 is a block diagram illustrating a configuration of a screen sharing apparatus according to a third exemplary embodiment of the present invention.

### EXEMPLARY EMBODIMENT

### First Exemplary Embodiment

A first exemplary embodiment according to the present invention will be described in detail with reference to the drawings.

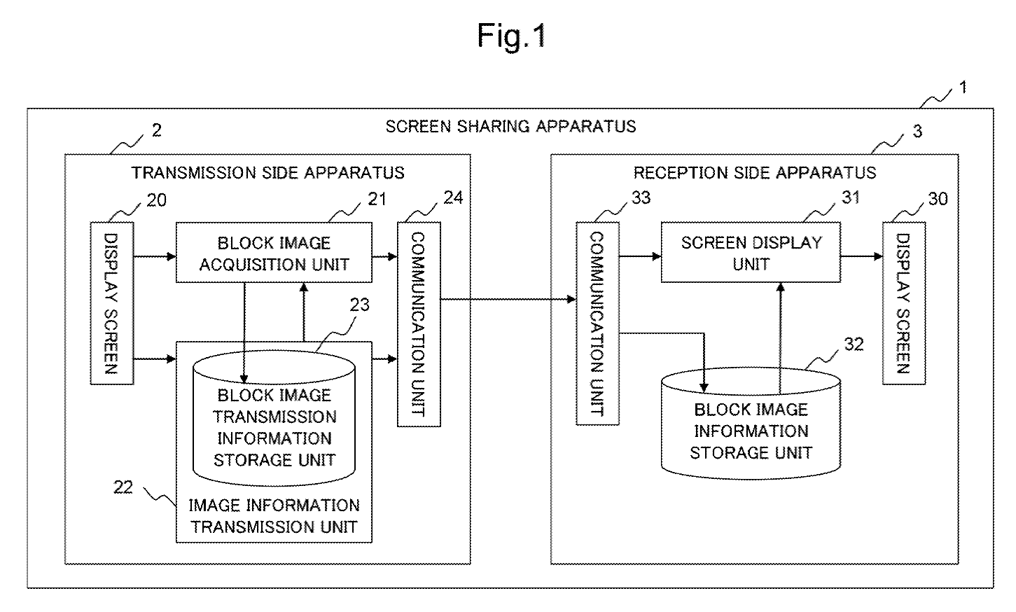

FIG. 1 is block diagram illustrating a configuration a of screen sharing apparatus according to this exemplary embodiment.

The screen sharing apparatus 1 according to this exemplary embodiment includes a transmission side apparatus 2 and a reception side apparatus 3. The transmission side apparatus 2 executes an application to display data related to execution screens therefor, and simultaneously transmits the data related to execution screens therefor to the reception side apparatus 3. The reception side apparatus 3 displays the received data related to execution screens on a screen thereof, and thereby, application screen sharing processing can be achieved between the transmission side apparatus 2 and the reception side apparatus 3.

The transmission side apparatus 2 includes a display screen 20, a block image acquisition unit 21, an image information transmission unit 22 and a communication unit 24. Moreover, the image information transmission unit 22 includes a block image transmission information storage unit 23.

The reception side apparatus 3 includes a display screen 30, a screen display unit 31, a block image information storage unit 32 and a communication unit 33.

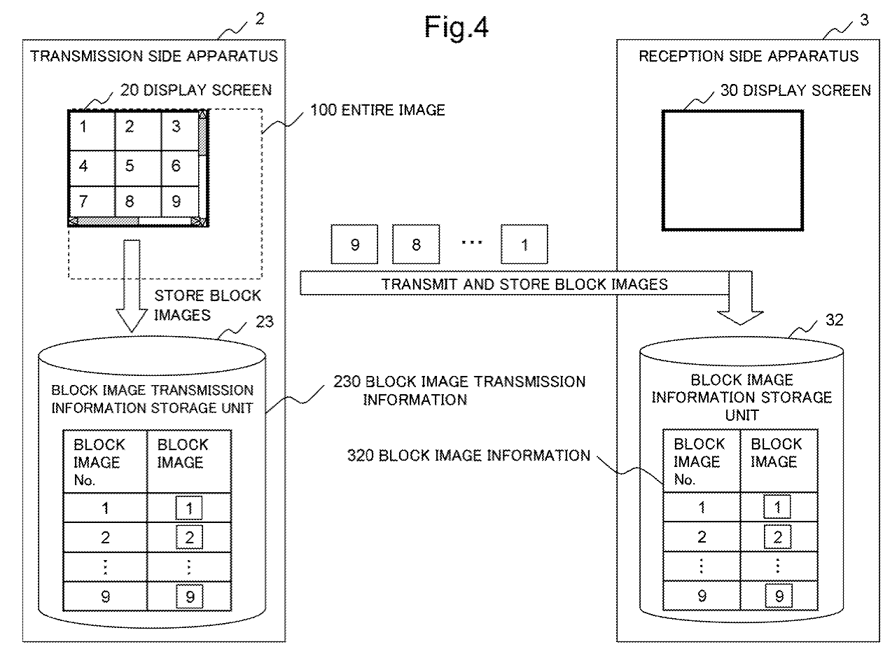

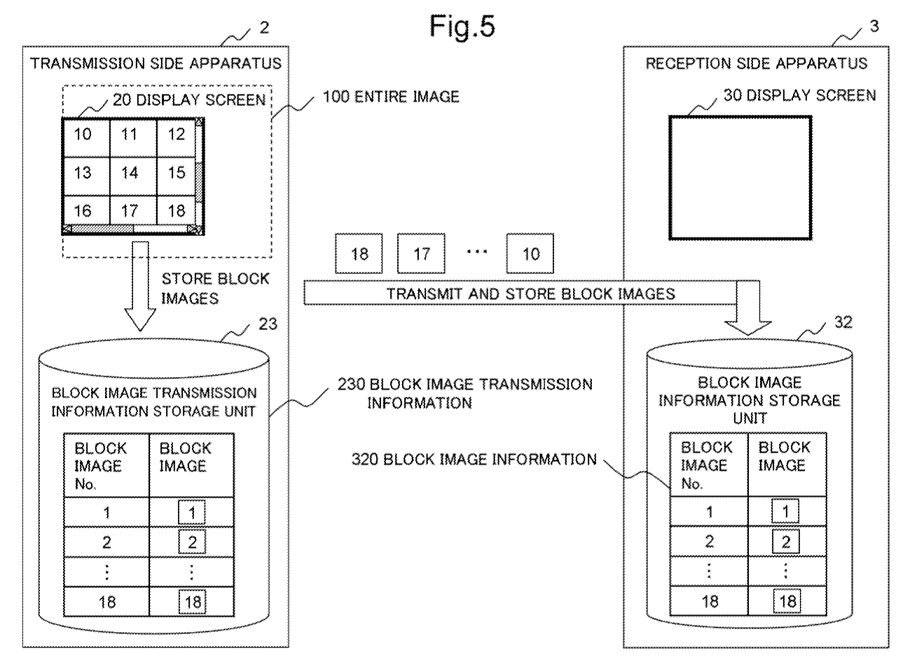

When beginning an application-execution-screen sharing processing procedure from the transmission side apparatus 2 to the reception side apparatus 3, the screen sharing apparatus 1 executes application sharing start processing as described below. The detail of the application sharing start processing is illustrated in FIGS. 4 and 5.

An entire image 100 is an image corresponding to all image data outputted by an application. During sharing of an application, a person in charge of operation of the application sequentially displays the entire image 100 on the display screen 20 by scrolling the entire image 100 on the display screen 20 on a screen-by-screen basis.

At the beginning of sharing of application execution screens, first, the block image acquisition unit 21 reads in a first display image having been displayed on the display screen 20. As shown in FIGS. 1 and 4, the block image acquisition unit 21 segments the image displayed on the display screen 20 into 9 (=3×3) block images, and gives identification IDs 1 to 9 to the respective block images. The block image acquisition unit 21 correlates pieces of data related to the respective nine block images with the identification IDs of the respective block images, and stores the resultant pieces of data and identification IDs into the block image transmission information storage unit 23 as block image transmission information 230.

The block image acquisition unit 21 transmits the block images having the respective identification IDs 1 to 9 to the reception side apparatus 3, together with the corresponding identification IDs, via the communication unit 24. The block image information storage unit 32 of the reception side apparatus 3 receives the block images having the respective identification IDs 1 to 9 and the corresponding identification IDs via the communication unit 33, and stores therein the received block images and corresponding identification IDs as block image information 320 so as to correlate the block images with the corresponding identification IDs.

Subsequently, the block image acquisition unit 21 causes the first display image on the display screen 20 to scroll by one screen, and reads in a second display image. The detail of an example of storage of block image data included in the second display image, performed by the block image acquisition unit 21, is illustrated in FIG. 5. The block image acquisition unit 21 segments the second display image into 9 block images, and gives identification IDs 10 to 18 to the respective block images, just like in the case of the first display image. The block image acquisition unit 21 correlates pieces of data related to the block images having respective identification IDs 10 to 18 with the corresponding identification IDs to store the resultant block images and corresponding identification IDs into the block image transmission information storage unit 23, and further, transmits them to the reception side apparatus 3 via the communication unit 24. The block image information storage unit 32 stores therein the received block images having respective identification IDs 10 to 18 and corresponding identification IDs.

Subsequently, the block image acquisition unit 21 sequentially displays a third display image and the following display images by scrolling a display image on the display screen 20 on a screen-by-screen basis, and performs processing similar to that described above on each of the display images. In the case where a display image having been read in subsequent to a scrolling of a display image on the display screen 20 is matched with an immediately previously read-in display image, the block image acquisition unit 21 determines that the display image is a last display image and the reading of the entire image 100 is complete. Further, the block image acquisition unit 21 returns the last image on the display screen 20 to the first display image by performing scrolling, and transmits a signal for reporting the completion of the application sharing start processing to the reception side apparatus 3.

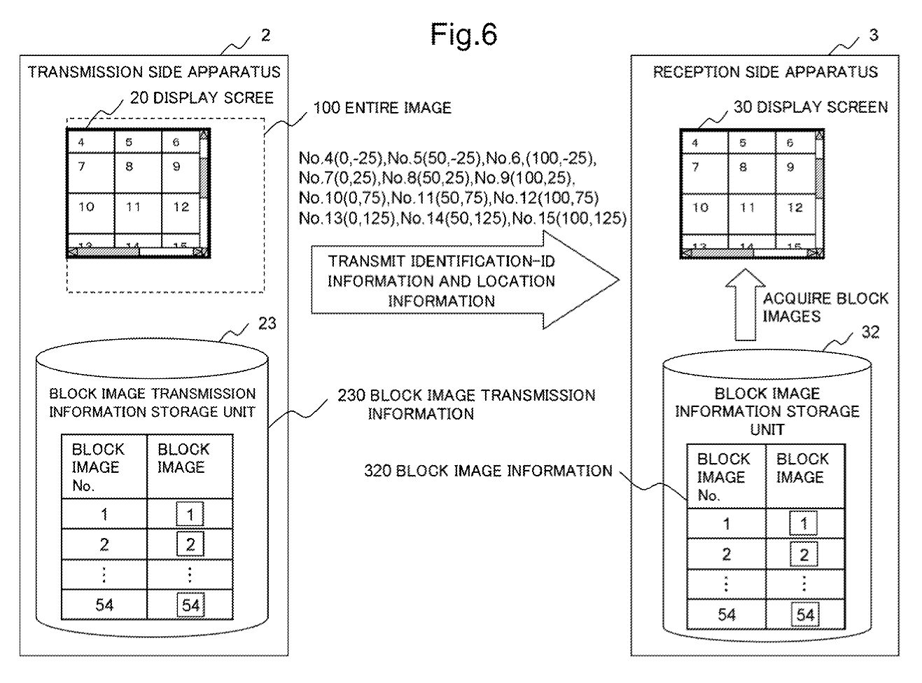

Upon completion of the above-described application sharing start processing, the screen sharing apparatus 1 starts application sharing processing. The detail of an example of operation of the screen sharing apparatus 1 in the case where there is no update in block image data included in a display image having been displayed on the display screen 20 is illustrated in FIG. 6.

The image information transmission unit 22 reads in a display image on the display screen 20, and performs pattern matching of part of the display image, which is included in a matching area, with each of fifty-four block images registered in the block image transmission information 230, while moving the coordinates of the matching area within the display image. As a result of the pattern matching, regarding each of three block images having respective identification IDs 4 to 6, the lower half of the image is matched. Regarding each of six block images having respective identification IDs 7 to 12, the whole of the image is matched. Regarding each of three block images having respective identification IDs 13 to 15, the upper half of the image is matched.

The image information transmission unit 22 calculates location information within the display screen 20 corresponding to each of the matched block images, that is, the coordinates of the upper-left vertex of each of the matched block images. The coordinates are determined such that the upper-left vertex of the display screen 20 is an original point, a direction extending in a right direction from the original point is a positive direction of an X-axis, and a direction extending in a lower direction from the original point is a positive direction of a Y-axis. The length of a side of each of the block images is 50, and the length of a side of the display screen 20 is 150. For example, since a block image having an identification ID 4 is in a state where the upper half portion thereof runs over the display screen 20, its coordinates are (0, −25). Similarly, the coordinates of a block image having an identification ID 8 are (50, 25), and the coordinates of a block image having an identification ID 15 are (100, 125).

The image information transmission unit 22 correlates the above-described pieces of location information with the identification IDs of the corresponding matched block images having the respective identification IDs 4 to 15, and transmits the resultant pieces of location information and corresponding identification IDs to the reception side apparatus 3 via the communication unit 24.

The image display unit 31 of the reception side apparatus 3 receives the identification IDs of the respective block images and the corresponding pieces of location information via the communication unit 33. The image display unit 31 reads out image data corresponding to the received identification IDs of the respective block images having the identification IDs 4 to 15 from the block image storage unit 32. Further, the image display unit 31 displays the read-out block images at positions within the display screen 30, indicated by the received corresponding pieces of location information. The length of a side of the display screen 30 is also 150, which is the same as that of the display screen 20.

Every time receiving identification ID information and location information related to block images from the transmission side apparatus 1, the image display unit 31 performs processing similar to that described above.

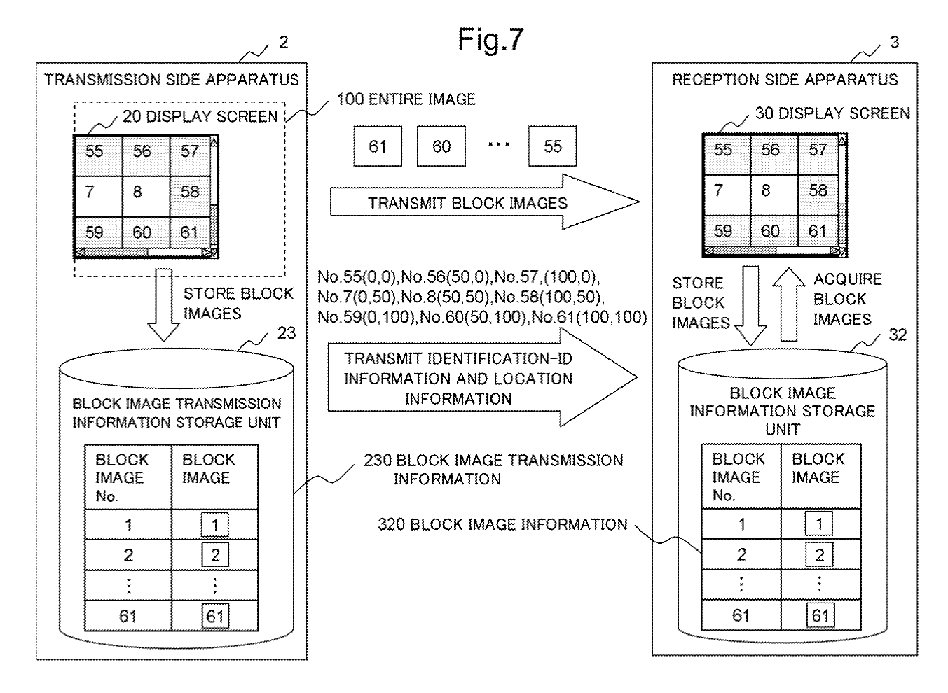

Next, the detail of an example of operation performed by the screen sharing apparatus 1 in the case where the update of the block image data occurs along with the update of the entire image 100 performed by an application during sharing of the application is illustrated in FIG. 7.

The image information transmission unit 22 performs pattern matching of each part of a display image on the display image 20 with the individual block images registered in the block image transmission information 230, and as a result, block images having respective identification IDs 7 and 8 are matched. The image information transmission unit 22 transmits the identification IDs 7 and 8 and corresponding pieces of location information to the reception side apparatus 3 via the communication unit 24.

In a remaining display area resulting from excluding portions matched with the block images having the respective identification IDs 7 and 8, there does not exist any block image which is matched with certain one of the block images registered in the block image transmission information 230, and thus, the image information transmission unit 22 determines that the remaining display area is a block-image unregistered area. The image information transmission unit 22 transmits location information indicating the block-image unregistered area to the block image acquisition unit 21 to instruct the addition of definitions of block images included in the block-image unregistered area.

The block image acquisition unit 21 reads in a display image on the display screen 20, segments the block-image unregistered area into seven block images, and gives identification IDs 55 to 61 to the respective block images. The block image acquisition unit 21 correlates pieces of data related to the block images having the respective identification IDs 55 to 61 with the corresponding identification IDs to store the resultant block images and corresponding identification IDs into the block image transmission information storage unit 23, and further, transmits them to the reception side apparatus 3 via the communication unit 24. The block image information storage unit 32 stores therein the received block images having respective identification IDs 55 to 61 and corresponding identification IDs.

The image information transmission unit 22 correlates identification IDs of the newly registered block images having the respective identification IDs 55 to 61 with corresponding pieces of location information, and transmits the resultant identification IDs and corresponding pieces of location information to the reception side apparatus 3 via the communication unit 24.

The image display unit 31 of the reception side apparatus 3 performs processing similar to that in the example shown in FIG. 6, and thereby, displays the block images having the respective identification IDs 7, 8 and 55 to 61 on the display screen 30.

When a person in charge of operation of the application inputs an application sharing termination command to the transmission side apparatus 2, the image information transmission unit 22 transmits an application sharing termination signal to the reception side apparatus 3 via the communication unit 24, and the application sharing processing is terminated.

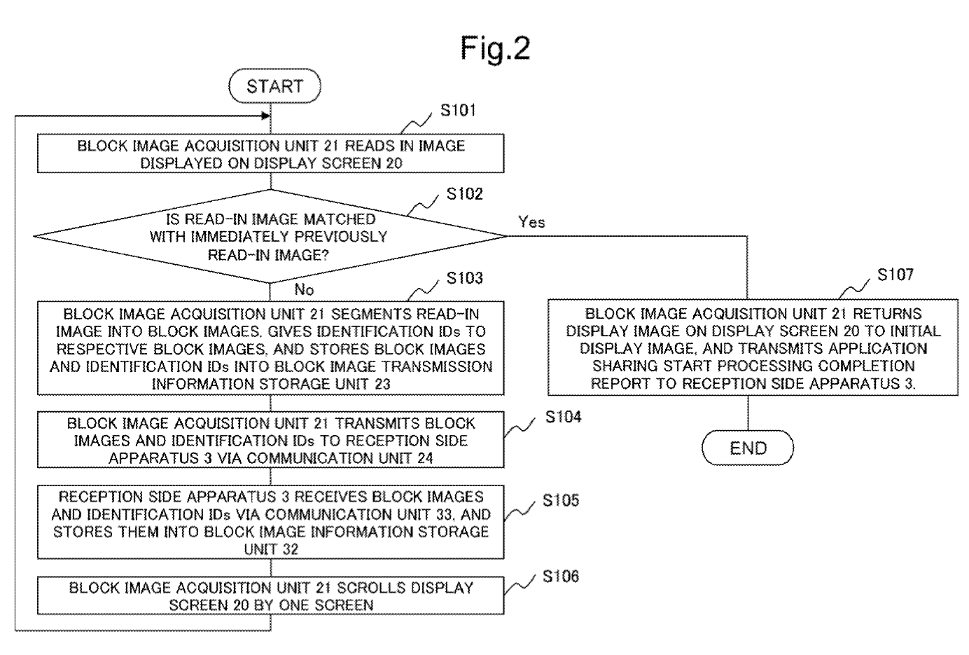

Next, the operation of application sharing start processing according to this exemplary embodiment will be described in detail with reference to a flowchart shown in FIG. 2.

The block image acquisition unit 21 reads in an image displayed on the display screen 20 (S101). If the read-in display image is not matched with an immediately previously read-in display image (“No” in S102), the block image acquisition unit 21 segments the read-in display image into block images, gives identification IDs to the corresponding block images, and stores the block images and the corresponding identification IDs into the block image transmission information storage unit 23 (S103).

The block image acquisition unit 21 transmits the block images and the corresponding identification IDs to the reception side apparatus 3 via the communication unit 24 (S104). The reception side apparatus 3 receives the block images and the corresponding identification IDs via the communication unit 33, and stores the received block images and corresponding identification IDs into the block image information storage unit 32 (S105). The block image acquisition unit 21 performs scrolling of the display screen 20 by one screen (S106), and returns the process flow to S101.

In S102, if a read-in display image is matched with an immediately previously read-in display image (“Yes” in S102), the block image acquisition unit 21 returns a display image on the display screen 20 to an initial display image, transmits an application sharing start processing completion report to the reception side apparatus 3 (S107), and the whole processing is terminated.

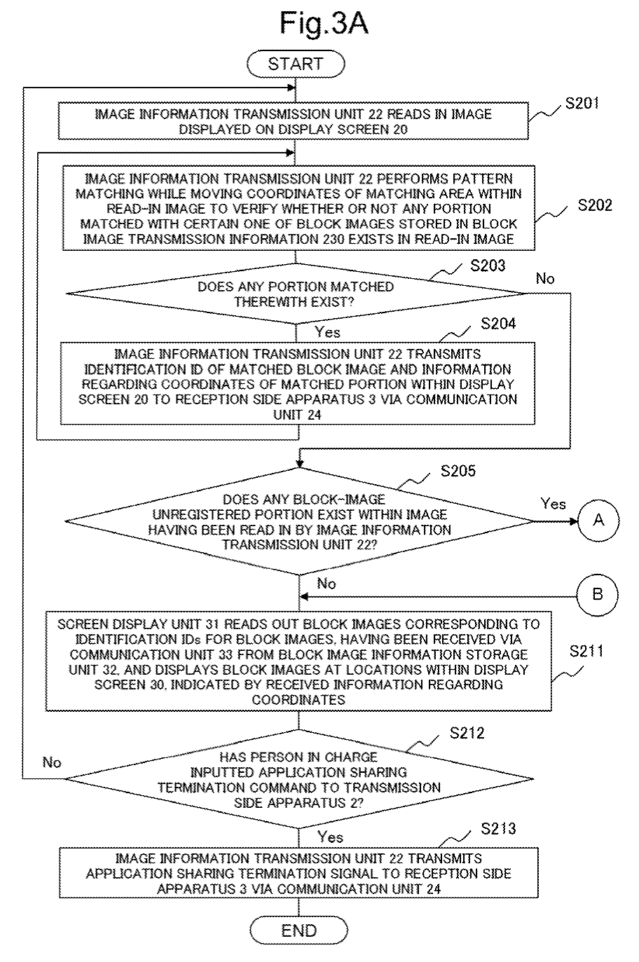

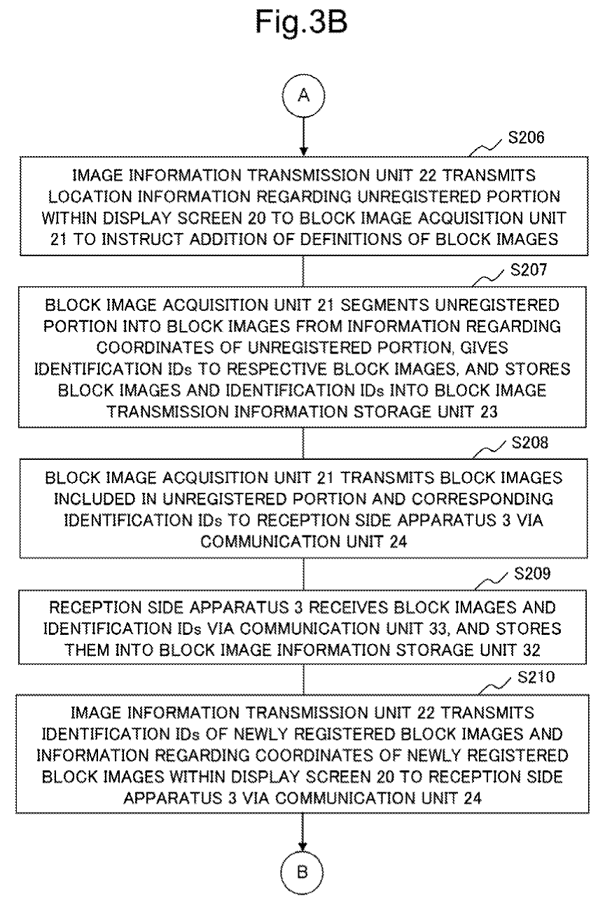

Next, operation during sharing of an application, according to this exemplary embodiment, will be described in detail with reference to flowcharts shown in FIGS. 3A and 3B.

The image information transmission unit 22 reads in an image displayed on the display screen 20 (S201). The image information transmission unit 22 performs pattern matching while moving the coordinates of a matching area within the read-in image to verify whether or not any portion matched with certain one of block images stored in the block image transmission information 230 exists in the read-in image (S202). If there exists any portion matched therewith (“Yes” in S203), the image information transmission unit 22 transmits an identification ID of the matched block image and information related to the coordinates of the matched portion within the display screen 20 to the reception side apparatus 3 via the communication unit 24 (S204), and the process flow returns to S202. If there does not any portion matched therewith (“No” in S203), the process flow proceeds to S205.

If there exists any block-image unregistered portion in the image having been read in by the image information transmission unit 22 (“Yes” in S205), the image information transmission unit 22 transmits location information related to the block-image unregistered portion within the display screen 20 to the block image acquisition unit 21 to instruct the addition of definitions of block images included in the block-image unregistered portion (S206). The block image acquisition unit 21 segments the block-image unregistered portion into block images from the location information related to the block-image unregistered portion, gives identification IDs to the respective segmented block images, and stores the block images and the corresponding identification IDs into the block image transmission information storage unit 23 (S207). The block image acquisition unit 21 transmits the block images included in the block-image unregistered portion and the corresponding identification IDs to the reception side apparatus 3 via the communication unit 24 (S208).

The reception side apparatus 3 receives the block images and the corresponding identification IDs via the communication unit 33, and stores the received block images and corresponding identification IDs into the block image information storage unit 32 (S209). The image information transmission unit 22 transmits the identification IDs of the newly registered block images and coordinate information within the display screen 20 related to the newly registered block images to the reception side apparatus 3 via the communication unit 24 (S210), and the process flow proceeds to S211.

If there does not exist any block-image unregistered portion in the image having been read in by the image information transmission unit 22 (“No” in S205), the screen display unit 31 reads out block images included in the block-image identification IDs, which have been received via the communication unit 33, from the block image information storage unit 32, and screen displays the read-out block images at respective locations within the display screen 30, indicated by the received coordinate information (S211).

If the person in charge of operation of the application does not input the application sharing termination command to the transmission side apparatus 2 (“No” in S212), the process flow returns to S201. If the person in charge of operation of the application inputs the application sharing termination command to the transmission side apparatus 2 (“Yes” in S212), the image information transmission unit 22 transmits the application sharing termination signal to the reception side apparatus 3 via the communication unit 24 (S213), and the whole processing is terminated.

This exemplary embodiment brings about an advantageous effect in that an application-execution-screen sharing processing procedure from the transmission side apparatus 2 to the reception side apparatus 3 can be performed at high speed. A reason of this is that, when performing sharing start processing, the transmission side apparatus 2 segments the entire execution screen handled by an application into block images and registers the resultant block images into the reception side apparatus 3 in advance. Further, during sharing of display screens, the transmission side apparatus 2 transmits only identification IDs and location information regarding block images included in a display image on the display screen 20 to the reception side apparatus 3. Moreover, the reception side apparatus 3 displays the display image of the display screen 20 on the display screen 30 on the basis of the registered block image data and the received identification IDs and location information described above.

The data size of the identification IDs and the location information is small compared with that of image data, and thus, the data size of data transmitted from the transmission side apparatus 2 to the reception side apparatus 3 becomes small. Moreover, in this exemplary embodiment, the block images included in the entire execution display screen handled by an application are registered in one lump when performing sharing start processing. Accordingly, even if a person in charge of operating the application switches display screens on a screen-by-screen basis, any transmission of block-image data from the transmission side apparatus 2 to the reception side apparatus 3 does not occur, provided that newly writing into a display image or the like is not performed during sharing of a display screen, and thus it is possible to eliminate a cause of slowing down the screen sharing processing.

### Second Exemplary Embodiment

Next, a second exemplary embodiment according to the preset invention will be described in detail with reference to the drawings.

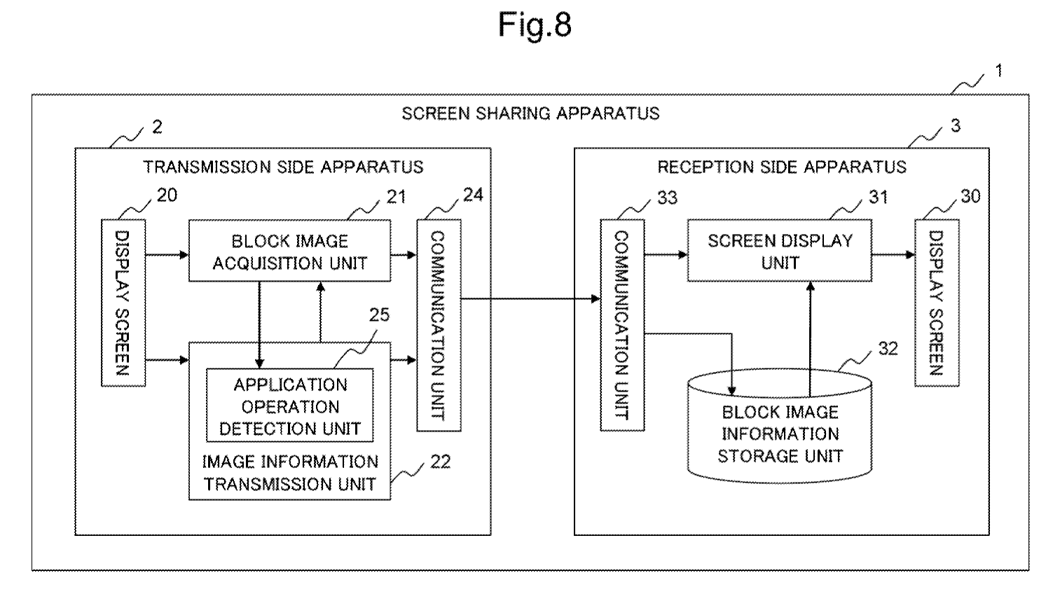

FIG. 8 is a block diagram illustrating a configuration of a screen sharing apparatus according to this exemplary embodiment.

The screen sharing apparatus 1 according to this exemplary embodiment is different from that according to the first exemplary embodiment in that the image information transmission unit 22 includes an application operation detection unit 25 in substitution for the block image transmission information storage unit 23 of the first exemplary embodiment.

The application operation detection unit 25 detects a screen operation command which is carried out by software being executed in the transmission side apparatus 2. The image information transmission unit 22 calculates pieces of location information related to respective block images included in a display image on the display screen 20 as of after an execution of the screen operation command, on the basis of information included in the detected screen operation command and location information related to a display image on the display screen 20 relative to the entire image 100 as of before the execution of the screen operation command.

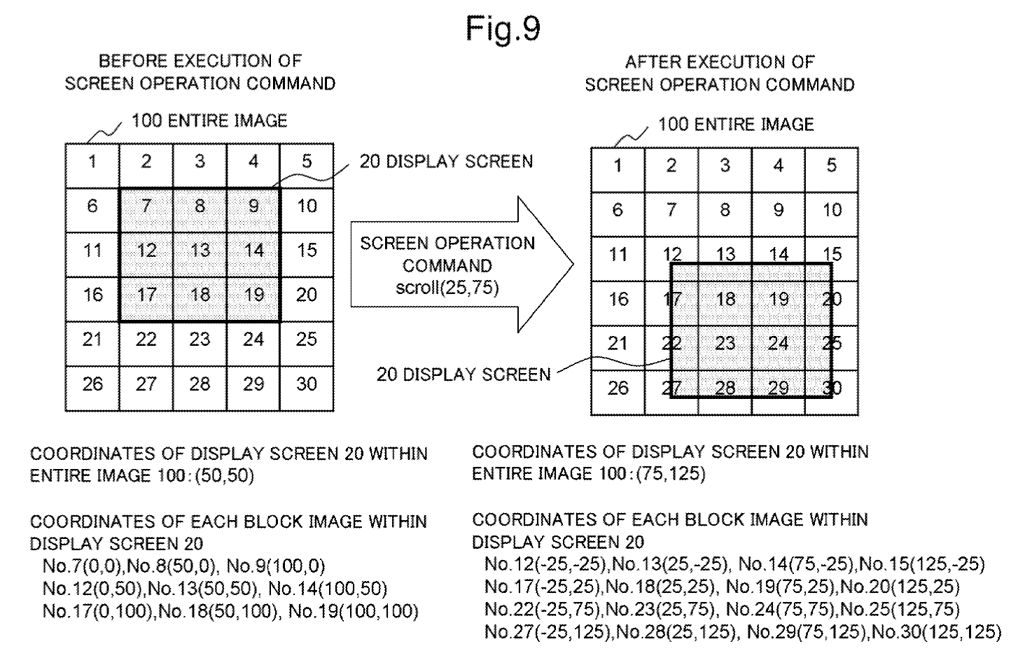

The detail of an example of calculation of location information related to block images performed by the image information transmission unit 22 in this exemplary embodiment is illustrated in FIG. 9. Currently, the display screen 20 is indicating block images corresponding to the identification IDs 7 to 9, 12 to 14 and 17 to 19. The length of a side of each of the block images is 50 just like in the case of the first exemplary embodiment, and under this condition, the coordinates of a vertex located at the upper left of the display screen 20 relative to the entire image 100 are (50, 50). In addition, the coordinates are determined such that the upper-left vertex of the entire image 100 is an original point, a direction extending in a right direction from the original point is a positive direction of an X-axis, and a direction extending in a lower direction from the original point is a positive direction of a Y-axis.

Under this condition, an application carries out a screen operation command “scroll (25, 75)” for scrolling a display image on the display screen 20 in the X-axis direction by “25”, and in the Y-axis direction by “75”. The application operation detection unit 25 detects the screen operation command “scroll (25, 75)” having been carried out. The image information transmission unit 22 calculates, from the information included in the detected screen operation command, that the coordinates of the display screen 20 relative to the entire image 100 as of after the execution of the screen operation command has moved to (75, 125). Once the coordinates of the display screen 20 has been determined, location information related to block images included in the display image 20 relative to the display image 20 are uniquely determined, and thus, the image information transmission unit 22 calculates the coordinates of the respective block images included in the display screen 20. In the case of the example shown FIG. 9, the display screen 20 includes block images having respective identification IDs 12 to 15, 17 to 20, 22 to 25 and 27 to 30, and the coordinates of the respective block images are as shown in FIG. 9. The image information transmission unit 22 correlates the calculated pieces of location information related to the respective block images with the identification IDs of the corresponding block images, and transmits the resultant pieces of location information and corresponding identification IDs to the reception side apparatus 3 via the communication unit 24. The following operation of the screen sharing apparatus 1 is similar to that of the first exemplary embodiment.

This exemplary embodiment brings about an advantageous effect in that an application-execution-screen sharing processing procedure from the transmission side apparatus 2 to the reception side apparatus 3 can be performed at high speed, and its reason is the same as that having been described in the first exemplary embodiment.

This exemplary embodiment brings about an advantageous effect in that a load on detection operation can be reduced to a greater degree as compared with that of the first exemplary embodiment, because the detection of the identification IDs and the location information of block images included in a display image on the display image 20 of the image information transmission unit 22 is made, not through the pattern matching between images such as that performed in the first exemplary embodiment, but through the calculation from information included in the screen operation command carried out by the relevant application.

Moreover, the image information transmission unit 22 does not need to include a database for block images such as the block image transmission information storage unit 23 of the first exemplary embodiment, and thus, this exemplary embodiment also has an advantageous effect of reducing the amount of hardware included in the screen sharing apparatus 1.

### Third Exemplary Embodiment

Next, a third exemplary embodiment according to the preset invention will be described in detail with reference to the drawing.

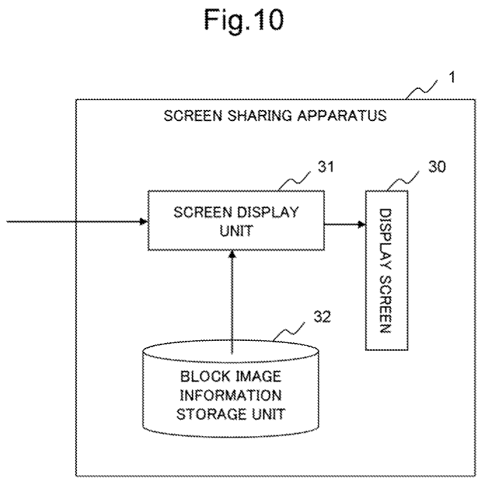

FIG. 10 is a block diagram illustrating a configuration of a screen sharing apparatus according to this exemplary embodiment.

The screen sharing apparatus 1 according to this exemplary embodiment includes a display screen 30, a display unit 31 and a block image information storage unit 32.

The block image information storage unit 32 stores therein block images and identification IDs for identifying the respective block images so as to correlate the block images with the corresponding identification IDs, wherein the block images are ones resulting from segmentation of an entire screen, part of which, that is, a display area, is scrolled and displayed on the display screen 30 by software executed in an external apparatus (not described).

The screen display unit 31 receives identification IDs corresponding to block images and location information indicating display locations of the respective block images within the display screen 30 from the external apparatus, and reads out block images corresponding to the respective identification IDs from the block image information storage unit 32 to display them at locations on the display screen 30, which are indicated by the location information described above.

This exemplary embodiment brings about an advantageous effect in that processing for allowing the display screen 30 to share application execution screens carried out in an external apparatus can be performed at high speed. A reason for this is that it is unnecessary to receive a large amount of data related to block images themselves, because the screen display unit 31 receives only identification IDs of the respective block images and location information related to the block images from the external apparatus, and reads out block images corresponding to the respective identification IDs from the block image information storage unit 32 to display them on the display screen 30.

This exemplary embodiment does not prescribe a method for registering the block images and the corresponding identification IDs for the application execution screens into the block image information storage unit 32. For example, a method which allows a person in charge of operation of the application to input the block images and the corresponding identification IDs to the block image information storage unit 32 in advance may be employed. In this case, provided that any change is not made on display images displayed by the application, the block image acquisition unit 21 included in each of the first and second exemplary embodiments is unnecessary, and thus, it is possible to realize the same advantageous effect as that of each of the first and second exemplary embodiments in a simpler apparatus configuration as compared with that of each of the first and second exemplary embodiments.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A screen reception apparatus comprising:
a block image information storage unit that stores therein a plurality of block images resulting from segmentation of an entire image which is scrolled by software so that a display area, which is part of said entire image, is displayed on a first screen, as well as identifications of said respective block images, such that said block images and said identifications are correlated with each other; and
an on-screen display unit that receives one of said identifications and display location within said first screen reads out from said block image information storage unit one of said block images corresponding to said received identification and, display said read out block image at said display location within said first screen.

2. A screen transmission apparatus comprising:
a block image acquisition unit that acquires said entire image by repeating screen capturing and scrolling on a second screen on which said display area is displayed and which has the same size as that of said first screen, creates said plurality of said block images, gives said identifications to said respective block images, and transmits said respective block images and said identifications to said screen reception apparatus of claim 1 in one lump; and
an image information transmission unit that transmits said identifications of said respective block images which are included in said display area displayed on said second screen, as well as said display locations calculated from locations of said respective block images on said second screen, to said screen reception apparatus, such that said identifications and said display locations are correlated with each other.

3. The screen transmission apparatus of claim 2, further comprising:
a block image transmission information storage unit that stores therein said plurality of block images created by said block image acquisition unit and said identifications, such that said block images and said identifications are correlated with each other,
wherein said image information transmission unit verifies matching of an image displayed on said second screen with each of said block images stored in said block image transmission information storage unit, and if any part of said image displayed on said second screen is matched with one of said block images stored in said block image transmission information storage unit, said image information transmission unit extracts said identification, which corresponds to said matched block image, from said block image transmission information storage unit.

4. The screen transmission apparatus of claims 2, further comprising:
software operation detection unit that detects a screen operation command executed by said software,
wherein, from coordinates of said display area within said entire image as of before an execution of said screen operation command, and an amount of movement of said display area in accordance with said screen operation command, said image information transmission unit acquires said identifications and said display locations of said block images included in said display area as of after the execution of said screen operation command, respectively.

5. A screen reception method comprising:
storing therein a plurality of block images resulting from segmentation of an entire image which is scrolled by software so that a display area, which is part of said entire image, is displayed on a first screen, as well as identifications of said respective block images, such that said block images and said identifications are correlated with each other to a first memory area; and
receiving one of said identifications and display location within said first screen reads out from said first memory area one of said block images corresponding to said received identification and, display said read out block image at said display location within said first screen.

6. A screen transmission method comprising:
acquiring said entire image by repeating screen capturing and scrolling on a second screen on which said display area is displayed and which has the same size as that of said first screen, creates said plurality of said block images, gives said identifications to said respective block images, and transmits said respective block images and said identifications to a reception apparatus which executes the screen reception method of claim 5 in one lump; and
transmitting said identifications of said respective block images which are included in said display area displayed on said second screen, as well as said display locations calculated from locations of said respective block images on said second screen, to said reception apparatus, such that said identifications and said display locations are correlated with each other.

7. The screen transmission method of claim 6, further comprising:
storing therein said plurality of block images created from said entire image and said identifications, such that said block images and said identifications are correlated with each other to a second memory area, and
verifying matching of an image displayed on said second screen with each of said block images stored in said second memory area, and if any part of said image displayed on said second screen is matched with one of said block images stored in said second memory area, extracting said identification, which corresponds to said matched block image, from said second memory area.

8. A non-transient computer-readable recording medium recording thereon a program which makes a computer function as:
a block image information storage unit that stores therein a plurality of block images resulting from segmentation of an entire image which is scrolled by software so that a display area, which is part of said entire image, is displayed on a first screen, as well as identifications of said respective block images, such that said block images and said identifications are correlated with each other; and
an on-screen display unit that receives one of said identifications and display location within said first screen reads out from said block image information storage unit one of said block images corresponding to said received identification and, display said read out block image at said display location within said first screen.

9. A non-transient computer-readable recording medium recording thereon a program which makes a computer function as:
a block image acquisition unit that acquires said entire image by repeating screen capturing and scrolling on a second screen on which said display area is displayed and which has the same size as that of said first screen, creates said plurality of said block images, gives said identifications to said respective block images, and transmits said respective block images and said identifications to a reception apparatus which makes the computer to execute said program recorded on the non-transient computer-readable recoding medium of claim 8 in one lump; and
an image information transmission unit that transmits said identifications of said respective block images which are included in said display area displayed on said second screen, as well as said display locations calculated from locations of said respective block images on said second screen, to said screen reception apparatus, such that said identifications and said display locations are correlated with each other.

10. The computer-readable recording medium according to claim 9, recording thereon said program which makes said computer function as:
block image transmission information storage unit that stores therein said block images having been created by said block image acquisition unit and said pieces of identification information, such that the said block images and the said pieces of identification information are correlated with each other,
wherein said image information transmission unit verifies matching of an image displayed on said second screen with each of said block images stored in said block image transmission information storage unit, and if any part of said image displayed on said second screen is matched with certain one of said block images stored in said block image transmission information storage unit, said image information transmission unit extracts a certain piece of said identification information, which corresponds to said certain one of said block images, from said block image transmission information storage unit.

11. A screen reception apparatus comprising:
block image information storage means for storing therein a plurality of block images resulting from segmentation of an entire image which is scrolled by software so that a display area, which is part of said entire image, is displayed on a first screen, as well as identifications of said respective block images, such that said block images and said identifications are correlated with each other; and
on-screen display means for receiving one of said identifications and display location within said first screen reads out from said block image information storage means one of said block images corresponding to said received identification and, display said read out block image at said display location within said first screen.
